(19) United States
(12) Patent Application Publication
(10) Pub. No.: US 2013/0171936 A1
(43) Pub. Date: Jul. 4, 2013

(54) Scheme for Relatively Low Power FM Transmissions

(71) Applicant: Cambridge Silicon Radio Limited, Cambridge (GB)

(72) Inventor: Timothy John Newton, Newmarket (GB)

(73) Assignee: CAMBRIDGE SILICON RADIO LIMITED, Cambridge (GB)

(21) Appl. No.: 13/631,834

(22) Filed: Sep. 28, 2012

(30) Foreign Application Priority Data
Sep. 28, 2011 (GB) 1116726.9

(51) Int. Cl. H04B 7/24

(52) U.S. Cl. CPC H04B 7/24
USPC 455/41.2

(57) ABSTRACT

Short range FM signal transmission apparatus comprising a generator configured to generate a set of FM transmissions occupying separate bands of frequencies and an RF transmitter configured to transmit the transmissions simultaneously.

### CROSS-REFERENCE TO RELATED APPLICATIONS

This application claims priority to GB 1116726.9 filed Sep. 28, 2011, the contents of which are incorporated herein by reference in its entirety.

### FIELD

The invention relates to the transmission of (frequency modulated) FM radio signals.

### BACKGROUND

The growing popularity in personal entertainment devices such as MP3 players has led to the creation of a new kind of auxiliary device which converts audio output from a personal entertainment device into a low power radio signal for acquisition by a radio receiver in a nearby entertainment system, which then recovers the audio signal and presents it to a listener.

Typically, these auxiliary devices are marketed as solutions for allowing personal entertainment device content to be enjoyed through an in car entertainment system. For this role, the auxiliary device will often take the form of a device that plugs into a personal entertainment device to receive audio output and which contains a short range FM transmitter for transmitting the audio content in a low power FM radio signal for acquisition by an FM receiver in a radio unit mounted in a car or other vehicle in which the personal entertainment device is being conveyed. The radio unit then recovers the audio content from the FM radio signal and presents it to occupants of the vehicle via speakers associated with the radio unit.

One problem with auxiliary devices of this kind is that the audio content is relayed in a low power radio signal that is easily swamped by other radio signals in the environment. Therefore, care must be taken to ensure that the radio signal used to relay the audio content is placed in a part of the radio spectrum that is otherwise unoccupied. However, radio spectrum activity varies with time and geographical location and this last factor is particularly important in the case of the automotive application outlined above: as a vehicle travels along, it might move into range of a commercial FM transmitter broadcasting in a channel that the auxiliary device is attempting to use to relay an audio signal to a radio unit integrated into the vehicle, with the result that the radio unit locks on to the output of the commercial transmitter rather than that of the auxiliary device.

### SUMMARY

According to one aspect, the present invention provides short range FM signal transmission apparatus comprising generating means for generating a set of FM transmissions occupying separate bands of frequencies and RF transmitting means for transmitting the transmissions simultaneously.

By providing multiple FM transmissions from the apparatus, there is an increased probability that a nearby receiver will be capable of successfully receiving output from the apparatus (i.e., it is unlikely at a given time and location that all of the FM transmissions from the apparatus will be swamped by other radio signals in the environment).

In some embodiments, two or more members of the set convey identical content. Thus, there is an increased probability that a nearby receiver will be capable of successfully receiving a desired content from the apparatus.

In certain embodiments, members of the set can be made to convey information permitting a receiver to locate the frequency band of at least one other member of the set. For example, this information can be incorporated into the FM transmissions using RDS (Radio Data System) or RBDS (Radio Broadcast Data System) technology.

In certain embodiments, the generating means can be arranged to subject an FM signal to mixing in order to produce two side band signals, each being a member of said set. Thus, if a radio unit cannot receive one of the side band signals due to swamping, the radio can attempt to receive the other side band signal instead.

In some embodiments, the generating means comprises upconverting means for frequency upconverting copies of an FM signal by different amounts, the upconverted copies being members of said set. Thus, if a radio unit cannot receive one of the upconverted copies, it can try and receive another one instead.

In some embodiments, the apparatus may also include transducing means and analysis means, wherein the transducing means is arranged to capture audio signals in the vicinity of the apparatus, the generating means is arranged to vary the band of frequencies occupied by a member of said set and the analysis means is arranged to detect in the captured audio signals the presence of information conveyed by said member. Thus, by listening to audio feedback from a nearby radio unit, the apparatus can determine the channel to which the radio unit is presently tuned, thus facilitating the interoperation of the apparatus and the radio unit.

In certain embodiments, the apparatus includes receiving means for receiving FM signals, wherein the receiving means is arranged to identify an unused FM channel and the generating means is arranged to place a member of said set in that channel.

According to another aspect, the present invention provides short range FM signal transmission apparatus comprising transmitting means for transmitting an FM radio signal, transducing means and analysis means, wherein the transducing means is arranged to capture audio signals in the vicinity of the apparatus, the transmitting means is arranged to vary the band of frequencies occupied by the FM radio signal and the analysis means is arranged to detect in the captured audio signals the presence of information conveyed by said FM radio signal.

Short range FM signal transmission apparatus according to the invention may, for example, form part of a radio telephone (conforming, say, to the UMTS standards) so as to enable audio content, such as MP3 files, stored in the telephone to be played through the speaker(s) of a nearby radio device (for example, one integrated in a vehicle).

### BRIEF DESCRIPTION OF THE DRAWINGS

By way of example only, certain embodiments of the invention will now be described by reference to the accompanying drawings, in which:

FIG. 1 is a schematic overview of a radio telephone;

FIG. 2 is a block diagram schematically illustrating a part of an FM transmission scheme within the telephone of FIG. 1;

FIG. 3 is a block diagram schematically illustrating another part of an FM transmission scheme within the telephone of FIG. 1; and

FIG. 4 is a block diagram schematically illustrating an alternative to the FM transmission scheme presented in FIGS. 2 and 3.

### DETAILED DESCRIPTION

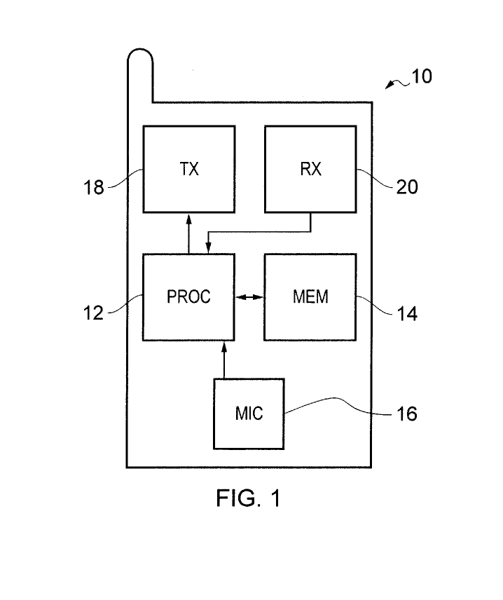

FIG. 1 shows a mobile telephone handset 10. Just the elements most closely associated with a description of an implementation of the invention are shown, it being apparent to the skilled person that in practice the telephone will include many more elements besides. As shown, the telephone 10 comprises a processor 12 for undertaking the majority of the digital data processing tasks required within the telephone, a memory 14 for storing data used in the processor's various activities, a microphone 16 for transducing sounds, e.g. speech for a voice call, into electrical signals manipulable by the processor, a transmit subsystem 18 and a receive subsystem 20.

In this example, the telephone 10 has the capability of playing through a nearby radio receiver, typically a radio unit mounted in a car dashboard, music tracks that are stored as MP3 files in memory 14. The music tracks are relayed wirelessly to the nearby radio receiver as FM modulation on an RF carrier signal.

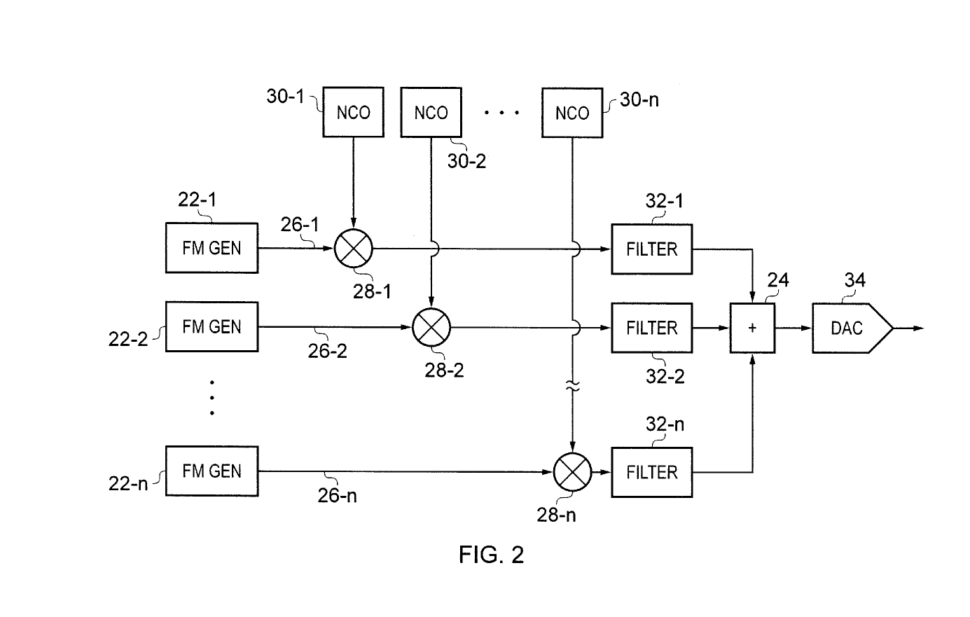

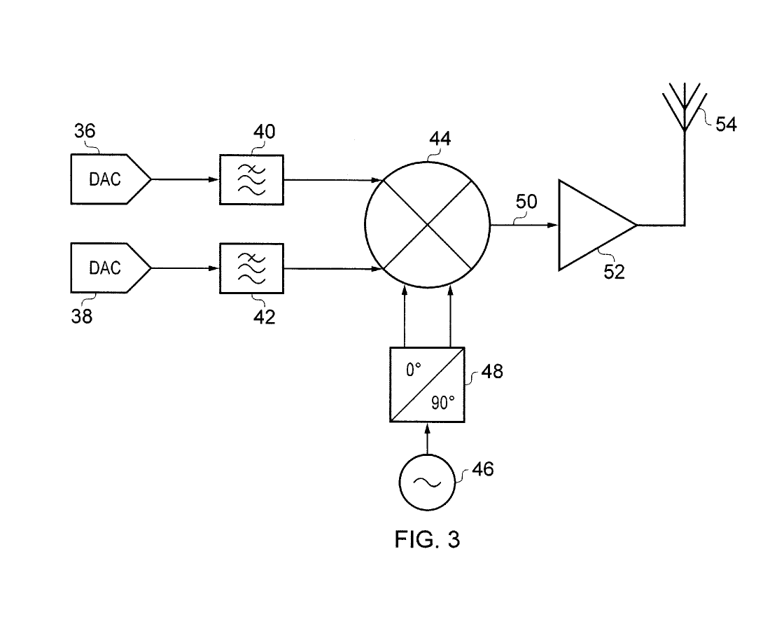

An MP3 file to be played through the nearby radio receiver is applied to a group of n FM generation processes running on the processor 12. Each of the FM generation processes produces an FM transmission in the form of a digital representation of an intermediate frequency (IF) carrier signal that is frequency modulated with RDS information and with the audio signal that the MP3 file represents. All members of the group of n FM transmissions thus produced utilise the same IF carrier frequency and they convey the same audio modulation. However, the FM transmissions differ in the content of their RDS information in a manner that will be explained later. The n FM transmissions are then supplied to the transmit subsystem 18, which is shown in FIGS. 2 and 3.

FIG. 2 shows the front end of the transmit subsystem 18. The n FM generation processes performed by the processor 12 are also shown, and they are labelled 22-1 through 22-n. Each of the n Fm transmissions undergoes a sequence of processing operations and then the FM transmissions are summed in an adder 24. In general terms, this sequence of processing operations is the same for each of the n FM transmissions so just the sequence of operations performed on FM transmission 26-1 from FM generation process 22-1 will now be described, it being understood that analogous sequences of operations are performed on the other FM transmissions.

The intermediate frequency FM transmission 26-1 is supplied to a mixer 28-1 where it is mixed with the output of a numerically controlled oscillator (NCO) 30-1. The output of the mixer 28-1 is then supplied to an image rejection filter 32-1, which eliminates the lower side band from the output of mixer 28-1. Thus, the signal that reaches adder 24 is version of the IF FM transmission 26-1 that has been upconverted in frequency by an amount equal to the operating frequency of the NCO 30-1. The operating frequency of the NCO 30-1 is set so as to cause (after further frequency upconversion to be described later with reference to FIG. 3) the IF FM transmission 26-1 to occupy a channel in the FM broadcast band of the radio spectrum. The signals that are sent to the adder 24 from the other FM generation process undergo analogous processing except that the NCOs 30-1 to 30-n each have different operating frequencies so the NCOs prepare the FM transmissions 26-1 to 26-n to occupy different channels of the FM broadcast band.

The sum of the upconverted FM transmissions is then fed through a DAC 34 to generate an analogue signal, which proceeds to the part of the transmit subsystem 18 that is shown in FIG. 3.

Before moving on to describe FIG. 3, it is important to note that FIG. 2 is simplified in that it does not reflect that the signals provided to the DAC 34 are in fact in quadrature format. In FIG. 3, the DAC 34 is redrawn more accurately as a first DAC 36 for the I channel output of the adder 24 and a second DAC 38 for the Q channel of output of the adder.

The outputs of DACs 36 and 38 are passed through respective reconstruction filters 40 and 42 (to smooth quantisation artefacts from the digital to analogue conversion) and together constitute a quadrature format input to a quadrature upconverter 44. The other input to the upconverter 44 is a carrier signal from a local oscillator 46 that has been rendered into a quadrature format by quadrature converter 48. The upconverter 44 converts the quadrature signal emitted by the reconstruction filters 40 and 42 into a signal 50 at RF lying in the FM broadcast band. The RF signal 50 then undergoes power amplification in an RF power amplifier (RFPA) 52 and is broadcast from an antenna 54. The RFPA 52 puts sufficient power into signal 50 to allow the signal to be received successfully up to a few meters away, but no further.

The upconverter 44 moves the analogue version of the summation created by adder 24 up in frequency to the FM broadcast band. However, the output of adder 24 is a summation of n FM transmissions that have been upconverted to different frequencies by NCOs 30-1 to 30-n. The total effect of these upconversions is to cause each of the n FM transmissions 26-1 to 26-n to be upconverted to a different channel of the FM broadcast band. The positioning of the n FM transmissions in the FM broadcast band depends on the settings of the NCOs 30-1 to 30-n, which are controlled by the processor 12. The processor 12 might be programmed to direct the NCOs 30-1 to 30-n to upconvert the n FM transmissions to a contiguous block of channels in the FM broadcast band or it might direct them to disperse the transmissions within the channels of the band.

It was mentioned earlier that each of the FM transmissions 26-1 to 26-n contains RDS data. In each of the FM transmissions 26-1 to 26-n, the RDS data specifies, inter alia, the channels of the FM broadcast band that the other n-1 transmissions occupy. Thus, for example, a car radio tuned to a channel of the FM broadcast band occupied by the output of one of the FM generation processes 22-1 to 22-n can, upon detecting that reception is becoming unreliable (for example because the car has moved into range of a commercial FM transmitter broadcasting in the same band), use the RDS data to retune itself to a channel of the FM broadcast band occupied by the output of one of the n−1 other FM generation processes so as to continue reception of the audio content that is driving the FM generation processes.

Some alternative embodiments of the invention will now be described, it being understood that the scope of protection sought for the invention is defined by the scope of the appended claims.

In one variant, for example, the FM generators 22-1 to 22-n need not all handle the same audio content. For example, FM generator 22-1 could process a different MP3 track to the other FM generators 22-2 to 22-n.

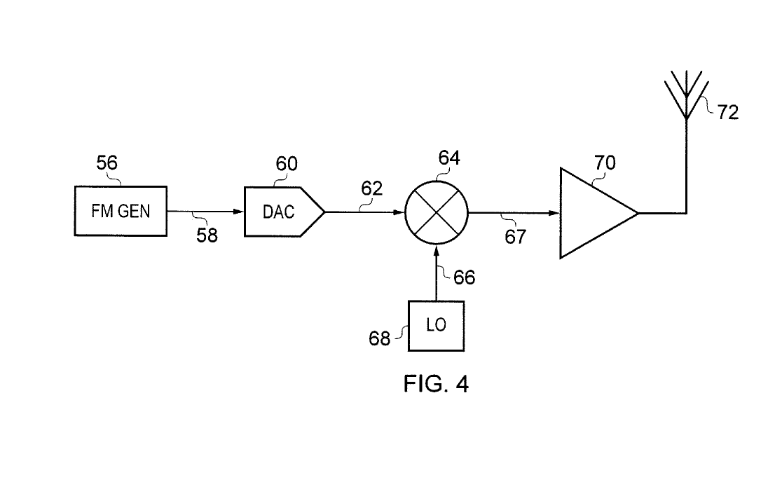

FIG. 4 shows an alternative embodiment for the transmit subsystem 18. In the FIG. 4 arrangement signals in two separate channels of the FM broadcast band are generated from the output of a single FM generation process 56 running on the processor 12. FM generation process 56 produces, in the same manner as processes 22-1 to 22-n, an IF FM transmission 58 with modulation representing audio content and RDS information. This signal is then converted into an analogue signal by DAC 60 and then subjected to reconstruction filtering (not shown). The resulting signal 62 is mixed in mixer 64 with a carrier signal 66 from local oscillator 68 to produce an RF signal 67 lying in the FM broadcast band. The signal 67 then undergoes amplification in RFPA 70 and is transmitted from antenna 72. As in subsystem 18, the amplification imposed by RFPA 70 is constrained to give the transmitted signal an effective range of just a few meters.

The mixer 64 operates without an image rejection mechanism such that signal 67 in fact contains two sidebands, one centred on a frequency below frequency of carrier signal 66 by an amount equal to the IF carrier frequency of signal 58 and another centred on a frequency above frequency of carrier signal 66 by an amount equal to the IF carrier frequency of signal 58. (In contrast, quadrature upconverter 44 contains an image rejection mechanism to suppress the lower frequency side band arising from the mixing of its inputs.) The two side bands thus occupy different channels of the FM broadcast band. The RDS information appearing the side band signals is necessarily the same but specifies, inter alia, the pair of channels that the side bands will occupy. Thus, a radio receiver acquiring the output of FM generator 56 from an FM channel containing one of the side bands will receive RDS information specifying the channel containing the other side band.

In all of the embodiments discussed above, the processor is capable of selecting the FM channels to which the audio content from memory 14 is allotted and the processor can change the selected channels as necessary. Often, the FM broadcast band is heavily populated and it can be difficult to find free channels in which the telephone can broadcast.

Accordingly, the processor 12 can in certain embodiments scan the FM broadcast band for available channels using receiver subsystem 20. In such embodiments, the processor will assess an FM channel by using the receiver subsystem 20 to measure the received signal power in that channel. The amended channel can then be deemed available if the measured signal power is below a threshold that would typically indicate that the channel does not contain a pre-existing FM signal of a strength likely to swamp the lower power FM transmission from the telephone 10.

In another variant, the microphone 16 is used to achieve a link between the telephone 10 and a radio receiver that is being used to attempt to play back audio content from the telephone. The processor 12 directs the transmit subsystem 18 to sweep through the channels of the FM broadcast band with an FM signal on to which a test audio signal has been modulated. When the processor 12 then detects via the microphone 16 that speakers associated with the targeted radio receiver are playing the test audio signal, the processor knows that it has identified the FM channel to which the targeted radio receiver is tuned. The test audio signal could be a signal outside the range of human audible frequencies and could be encoded or patterned in such a way that the processor can easily correlate with the test audio signal returning via the microphone 16.

What is claimed is:

1. Short range FM signal transmission apparatus comprising a generator configured to generate a set of FM transmissions occupying separate bands of frequencies and an RF transmitter configured to transmit the transmissions simultaneously.

2. Apparatus according to claim 1, wherein at least two members of the set convey identical content.

3. Apparatus according to claim 1, wherein at least one member of the set conveys information permitting a receiver to locate the frequency band of at least one other member of the set.

4. Apparatus according to claim 3, wherein the information is conveyed in accordance with the RDS or RBDS scheme.

5. Apparatus according to claim 1, wherein the generator is arranged to subject an FM signal to mixing to produce two side band signals, each being a member of said set.

6. Apparatus according to claim 1, wherein the generator comprises an upconverter configured to frequency upconvert copies of an FM signal by different amounts, the upconverted copies being members of said set.

7. Apparatus according to claim 1, further comprising a transducer and an analyser, wherein the transducer is arranged to capture audio signals in the vicinity of the apparatus, the generator is arranged to vary the band of frequencies occupied by a member of said set and the analyser is arranged to detect in the captured audio signals the presence of information conveyed by said member.

8. Apparatus according to claim 1, further comprising a receiver configured to receive FM signals, wherein the receiver is arranged to identify an unused FM channel and the generator is arranged to place a member of said set in that channel.

9. Short range FM signal transmission apparatus comprising a transmitter configured to transmit an FM radio signal, a transducer and an analyser, wherein the transducer is arranged to capture audio signals in the vicinity of the apparatus, the transmitter is arranged to vary the band of frequencies occupied by the FM radio signal and the analyser is arranged to detect in the captured audio signals the presence of information conveyed by said FM radio signal.

10. A radio telephone comprising a short range FM signal transmission apparatus, the short range FM signal transmission apparatus comprising a generator configured to generate a set of FM transmissions occupying separate bands of frequencies and an RF transmitter configured to transmit the transmissions simultaneously.
